(19) United States
(12) Patent Application Publication
(10) Pub. No.: US 2016/0327158 A1
(43) Pub. Date: Nov. 10, 2016

(54) SHIFTING DEVICE FOR A MOTOR VEHICLE TRANSMISSION

(71) Applicant: GM GLOBAL TECHNOLOGY OPERATIONS LLC, Detroit, MI (US)

(72) Inventor: Mathias REMMLER, Ruesselsheim (DE)

(73) Assignee: GM GLOBAL TECHNOLOGY OPERATIONS LLC, Detroit, MI (US)

(21) Appl. No.: 15/145,997

(22) Filed: May 4, 2016

(30) Foreign Application Priority Data
May 4, 2015 (DE) 102015005705.7

(51) Int. Cl. F16H 63/20; F16H 3/00

(52) U.S. Cl. CPC F16H 63/20; F16H 3/006; F16H 2200/0056

(57) ABSTRACT

A shifting device for a motor vehicle transmission, with an actuator having a first actuating member of the actuator can be adjusted into a first gear selection position in order to engage a gear of the motor vehicle transmission. The actuator includes an additional actuating member that in the first gate selection position can be adjusted into an additional gear selection position in order to engage an additional gear of the motor vehicle transmission. The actuator can be adjusted into one or more further gate selection positions that differ from the first gate selection position and in which a further actuating member of the actuator can be adjusted into a gear selection position in order to engage this additional gear of the motor vehicle transmission.

### CROSS-REFERENCE TO RELATED APPLICATION

This application claims priority to German Patent Application No. 102015005705.7, filed May 4, 2015, which is incorporated herein by reference in its entirety.

### TECHNICAL FIELD

The present disclosure pertains to a shifting device for a motor vehicle transmission, a motor vehicle transmission arrangement and a motor vehicle with the shifting device, as well as to a method for engaging and/or disengaging gears of the motor vehicle transmission arrangement.

### BACKGROUND

In a manual transmission, the gearwheels of pairs of numerically successive gears such as, for example, a first and a second forward gear, are arranged adjacent to one another on the same gear shaft and therefore can be respectively engaged and disengaged with oppositely directed shifting motions of a gear shift lever that is arranged in a corresponding shift gate and displaces a first synchronization device or simply a first synchronizer in the opposite direction via a first selector shaft and selector fork. If the gear shift lever is arranged in a parallel shift gate, it displaces a second, different selector shaft in the opposite direction in order to thereby respectively engage and disengage the gearwheels of another pair of numerically successive gears such as, for example, a third and a fourth forward gear, which are once again arranged adjacent to one another on the same gear shaft. This results in a conventional H-gearshift system with numerically successive forward gears, in which odd-numbered forward gears are arranged on one side and even-numbered forward gears are arranged on an opposite side.

### SUMMARY

The present disclosure provides an improve gearshift system of a motor vehicle transmission. According to an aspect of the present disclosure, a motor vehicle, particularly a passenger car, features a motor vehicle transmission arrangement with a motor vehicle transmission having several forward gears, as well as a shifting device for selectively engaging and disengaging these gears. In one embodiment, the motor vehicle transmission may, in particular, include a dual clutch transmission. The motor vehicle transmission may additionally or alternatively have seven or more numerically successive forward gears and/or a high-torque starting gear for heavy loads.

According to an aspect of the present disclosure, the shifting device or a shifting device features a one-piece or multi-piece actuator that can be adjusted into a first gate selection position in a gate selecting direction. In one embodiment, the actuator can be axially adjusted in a gate selecting direction and is mounted such that it can be rotationally adjusted in and opposite to a gear selecting direction about this axis. It may feature or, in particular, include a selector shaft. The actuator may likewise be rotationally adjustable in a gate selecting direction and mounted such that it can be axially adjusted in and opposite to a gear selecting direction along the rotational axis.

In one embodiment, the actuator can be functionally connected, particularly is functionally connected, to an input device mechanically, hydraulically, pneumatically and/or in an electric or(electrically) signaling fashion. The input device features an input means, particularly a gearshift lever, which can be moved in accordance with an H-gearshift pattern, particularly in a gate-guided fashion, in order to selectively shift gears or to respectively engage or disengage gears of the transmission. In an embodiment, a gearshift lever that is functionally connected to the actuator accordingly has, in particular, a gate-guided H-gearshift pattern.

In an embodiment, the actuator features a first actuating member that, in particular, is rigidly fixed on the actuator and respectively can be adjusted or is adjusted into a first gear selection position by moving the actuator, which is respectively adjusted into the first gate selection position or arranged in the first gate selection position, in the gear selecting direction.

In an embodiment, the shifting device features a contour arrangement with a first contour that has an engagement (contour) section. In an embodiment, the first contour can be functionally connected, particularly is functionally connected, to a first shifter mechanically, hydraulically, pneumatically and/or in an electric or (electrically) signaling fashion in order to engage a gear of the motor vehicle transmission. The first shifter may feature or, in particular, include a synchronizer for rotationally fixing a transmission member of the motor vehicle transmission, particularly a gearwheel, on a gear shaft. Accordingly, the first contour can be functionally connected, particularly is functionally connected, to the first shifter, particularly the first synchronizer, by a first selector shaft and/or selector fork. In an embodiment, the engagement of a gear generally includes the process of rotationally fixing a transmission member of the gear, particularly a gearwheel, on a gear shaft in a mechanical fashion and the disengagement of the gear accordingly includes the process of rotationally decoupling or rotationally releasing the transmission member, particularly the gearwheel, in a mechanical fashion.

In an embodiment, the first contour respectively can be adjusted or is adjusted into the first gear selection position due to an engaging adjustment of the first actuating member, which particularly cooperates with its engagement section in a form-fitting fashion, in the gear selecting direction. The first contour respectively engages or is designed for engaging this gear via the first shifter functionally connected thereto.

According to an aspect of the present disclosure, the actuator features an additional actuating member that, in particular, is rigidly fixed on the actuator and respectively can be adjusted or is adjusted into an additional gear selection position by moving the actuator, which is respectively adjusted into the first gate selection position or arranged in the first gate selection position, opposite to the gear selecting direction. In an embodiment, the contour arrangement features an additional contour that has an engagement (contour) section.

In an embodiment, the additional contour can be functionally connected, particularly is functionally connected, to an additional shifter, particularly a separate shifter, which differs from the first shifter, mechanically, hydraulically, pneumatically and/or in an electric or (electrically) signaling fashion in order to engage an additional gear of the motor vehicle transmission. The additional shifter may feature or, in particular, includes an additional synchronizer for rotationally fixing another transmission member of the motor vehicle transmission, particularly a gearwheel, on a gear shaft. Accordingly, the additional contour can be functionally connected, particularly is functionally connected, to the additional shifter, particularly the additional synchronizer, by an additional selector shaft and/or selector fork that differs from the first selector shaft.

In an embodiment, the additional contour respectively can be adjusted or is adjusted into the additional gear selection position due to an engaging adjustment of the additional actuating member, which particularly cooperates with its engagement section in a form-fitting fashion, opposite to the gear selecting direction. The additional contour respectively engages or is designed for engaging this additional gear via the additional shifter functionally connected thereto.

Since one gear is in an embodiment engaged by the first actuating member, the first contour cooperating therewith and the first shifter that is functionally connected to the first contour due to a motion of the actuator, which is arranged in the first gate selection position, in the gear selecting direction, and the additional gear is engaged by the additional actuating member, the additional contour cooperating therewith and the additional shifter that is functionally connected to the additional contour due to an oppositely directed motion of the actuator, which is likewise arranged in the first gate selection position, opposite to the gear selecting direction, numerically successive gears or the gear stages, the transmission members of which are not engaged by the same shifter, particularly gears or gear stages with gearwheels that are not arranged directly adjacent to one another on the same gear shaft, can in an embodiment also be advantageously shifted in conventional fashion, particularly in a shift gate of an H-gearshift pattern.

According to another aspect of the present disclosure that may be combined, in particular, with the above-described aspect, the actuator is (mounted) adjustable in such a way that it can be (selectively) adjusted into another gate selection position that differs from the first gate selection position.

In an embodiment, the actuator features an additional actuating member, particularly an actuating member that differs from the first actuating member and/or is rigidly fixed on the actuator, which respectively can be adjusted or is adjusted into a gear selection position due to a motion of the actuator, which is respectively adjusted into the other gate selection position or arranged in the other gate selection position, in or opposite to the gear selecting direction. In order to describe the present disclosure in a more concise fashion, this gear selection position of the additional actuating member in the other gate selection position is also referred to as additional gear selection position below. It may particularly correspond to the first gear selection position of the first actuating member or the additional gear selection position of the additional actuating member in the first gate selection position.

In an embodiment, the contour arrangement includes a further contour that has an engagement (contour) section and, in particular, differs from the first contour and, if applicable, the additional contour.

In an embodiment, the further contour can be functionally connected, particularly is functionally connected, to the first shifter mechanically, hydraulically, pneumatically and/or in an electric or (electrically) signaling fashion. The further contour can be functionally connected, particularly is functionally connected, to the first shifter, particularly the first synchronizer, by a further selector shaft and/or selector fork that differ from the first selector shaft and/or selector fork. The first shifter is in an embodiment generally designed for also engaging and/or disengaging a further gear that differs from the first gear and, if applicable, the additional gear.

In an embodiment, the further contour respectively can be adjusted or is adjusted into the (further) gear selection position due to an engaging adjustment of the further actuating member, which particularly cooperates with its engagement section in a form-fitting fashion. The further contour respectively engages or is designed for engaging the further gear, which differs from the first gear, via the first shifter functionally connected thereto.

Since the same first shifter respectively can be adjusted or is adjusted in opposite directions in an embodiment due to a corresponding engaging adjustment of the first actuating member into the first gear selection position in the first gate selection position or of the further actuating member into the further gear selection position in the other gate selection position, numerically non-successive gears or gear stages, the transmission members of which are engaged by the same shifter, particularly gears or gear stages with gearwheels that are arranged directly adjacent to one another on the same gear shaft, can in an embodiment also be advantageously shifted in conventional fashion, particularly in different shift gates of an H-gearshift pattern.

In an embodiment, the further actuating member may be arranged on the actuator such that it is respectively offset or turned by 180° relative to the first actuating member in order to be respectively adjustable or adjusted into the further gear selection position, which therefore may correspond to the first gear selection position of the first actuating member, due to a motion in the gear selecting direction. In an embodiment, this advantageously makes it possible to respectively shift even-numbered gears on the one hand and odd-numbered gears on the other hand in the same moving direction of the actuator. It is possible, for example, to shift a first, third and fifth gear due to a rotation of the actuator and a second, fourth and sixth gear due to an oppositely directed rotation of the actuator.

A pairing of the further actuating member and the further contour with a (further) additional actuating member and a (further) additional contour may also be provided analogous to the pairing of the first and the additional actuating member and the first and the additional contour.

In an embodiment, the actuator accordingly includes a further additional actuating member that can be adjusted into a (further additional) gear selection position, particularly opposite to or in the gear selecting direction, in the other gate selection position. The contour arrangement features a further additional contour with an engagement section, which can be functionally connected to a further additional shifter that differs from the first shifter in order to engage a further additional gear of the motor vehicle transmission and respectively can be adjusted or is adjusted or is designed for being adjusted into this (further additional) gear selection position in order to engage this further additional gear due to an engaging adjustment of the further additional actuating member that cooperates with the engagement section of the further additional contour.

In an embodiment, the further additional actuating member can be arranged on the actuator such that it is respectively offset or turned by 180° relative to the additional actuating member in order to be adjustable or adjusted into the further additional gear selection position, which therefore may correspond to the additional gear selection position of the additional actuating member, due to a motion opposite to the gear selecting direction.

In an enhancement, the shifting device may in addition to the pairing of the first and the additional actuating member and the first and the additional contour and the pairing of the further and the further additional actuating member and the further and the further additional contour analogously feature one or more additional and/or one or more further actuating members and contours, in particular, in order to thereby shift a dual clutch transmission and/or a motor vehicle transmission that features a high-torque starting gear for heavy loads and/or at least seven forward gears. Two or more pairs of numerically successive gears can in an embodiment respectively be shifted in a shift gate of an H-gearshift pattern, the transmission members of which are not engaged by the same shifter. This represents an advantageous utilization of the present disclosure, which is not restricted to this utilization, but in an embodiment generally provides an advantageous variable assignment of gate selection positions and gear selection positions to gears or transmission members or shifter for the engagement and/or disengagement thereof.

In an embodiment, two or more actuating members and/or two or more contours are spaced apart from one another in the gate selecting direction. In an embodiment, the first actuating member and the first contour are arranged at the same height in the gate selecting direction and/or the additional actuating member and the additional contour are arranged at the same height, which differs from the height of the first actuating member and the first contour, in particular, only when the actuator is arranged in the first gate selection position. The further actuating member and the further contour are arranged at the same height in the gate selecting direction, which differs from the height of the first and the additional actuating member and the first and the additional contour, and/or the further additional actuating member and the further additional contour are arranged at the same height in the gate selecting direction, which differs from the height of the further actuating member and the further contour, in particular, only when the actuator is arranged in the other gate selection position.

An actuating member may feature, in particular, a so-called shift finger.

In an embodiment, one or more contours respectively feature a disengagement section and respectively are adjustable or adjusted or designed for being adjusted due to a disengaging adjustment of the actuating member cooperating with the contour, which is directed opposite to the engaging adjustment, in order to disengage the gear engaged due to the engaging adjustment. In this way, a gear engaged due to an engaging adjustment of the actuating member cooperating with the contour can in an embodiment be advantageously disengaged once again due to an oppositely directed disengaging adjustment of the actuating member and the motor vehicle transmission can in an enhancement be shifted, in particular, into a neutral position.

In an embodiment, one or more contours respectively feature a free-running section that allows an adjustment of the actuating member, which is directed opposite to an engaging adjustment of the actuating member, beyond a neutral position without adjustment of the contour. In this way, it is in an embodiment advantageously possible to selectively shift into the first gear selection position with the first contour and the first actuating member cooperating therewith or into the additional gear selection position with the additional contour and the additional actuating member cooperating therewith without the additional actuating member simultaneously shifting the additional contour into the additional gear selection position or the first actuating member shifting the first contour into the first gear selection position, but rather moving at a distance from the free-running section.

In an embodiment, one or more contours and the actuator respectively feature locking contour sections for blocking an adjustment of the contour in one or more gate selection positions.

In an enhancement, one or more actuating members respectively feature a one-piece or multi-piece locking contour section for blocking an adjustment of a contour without an engaging and disengaging adjustment of an actuating member cooperating with the contour, particularly for blocking an adjustment of a contour due to an adjustment of the actuating member cooperating with the contour, which is directed opposite to an engaging adjustment of the actuating member, beyond the neutral position.

In an enhancement, the actuator additionally or alternatively features one or more locking contour sections for blocking an adjustment of a contour into a gate selection position, in which none of the actuating members cooperates with the contour. In this way, it is in an embodiment advantageously possible to prevent an undesirable adjustment of the respective contour without the actuator being in the gate selection position assigned to this contour.

In an embodiment, the gears that can be engaged with the first shifter and the additional gears that can be engaged with the additional shifter form numerically successive gears, particularly a first and second, a third and fourth or a fifth and sixth gear. As mentioned above, pairs of numerically successive gears thereby can in an embodiment be advantageously shifted in conventional fashion through or in the same shift gate of an H-gearshift pattern although the some shifter does not shift these gears, but the present disclosure is not limited to this utilization. It also was already mentioned above that an embodiment of the present disclosure generally provides an advantageous variable assignment of gear selection position and gate selection positions to shifter or transmission members of gears. Accordingly, the gear that can be engaged with the first shifter and the additional gear that can be engaged with the additional shifter feature in an embodiment different shafts and/or gearwheels of the motor vehicle transmission, which are axially separated by one or more gearwheels.

According to an aspect of the present disclosure, gears of a motor vehicle transmission arrangement described herein are engaged and/or disengaged, in particular, by respectively rotationally fixing or rotationally decoupling at least one transmission member of the corresponding gear to/from a gear shaft, wherein the actuator is selectively adjusted into and/or from a gear selection position manually or by the input device, particularly in accordance with an H-gearshift pattern.

### BRIEF DESCRIPTION OF THE DRAWINGS

The present disclosure will hereinafter be described in conjunction with the following drawing figures, wherein like numerals denote like elements.

FIG. 1 shows a motor vehicle transmission arrangement of a motor vehicle with several sections through a shifting device according to an embodiment of the present disclosure;

FIG. 2 shows the sections according to FIG. 1 for a first gear selection position;

FIG. 3 shows the sections according to FIGS. 1-2 for an additional gear selection position;

FIG. 4 shows the sections according to FIGS. 1-3 for another gate selection position;

FIG. 5 shows the motor vehicle transmission arrangement according to FIG. 1 with an additional section through the shifting device for the other gate selection position; and

FIG. 6 shows the right section shown in FIG. 4 and the additional section shown in FIG. 5 for a motor vehicle transmission arrangement of a motor vehicle according to another embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

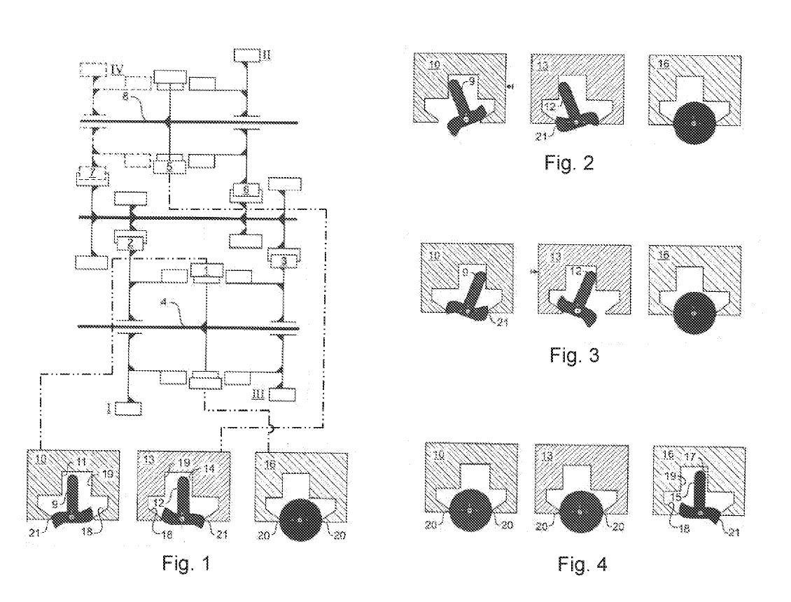

FIG. 1 shows in the left region part of a motor vehicle transmission of a motor vehicle transmission arrangement of a motor vehicle according to an embodiment of the present disclosure. A first forward gear I, a second forward gear II, a third forward gear III and, in broken lines, a fourth forward gear IV are indicated in an exemplary fashion. The gears I, III are shifted in that a first shifter in the form of a first synchronizer 1 rotationally fixes either a first gearwheel 2 (first gear I, left in FIG. 1) or a second gearwheel 3 (third gear III) on a gear shaft 4. The gears II, IV are shifted in that a further shifter in the form of a further synchronizer 5 rotationally fixes either a third gearwheel 6 (second gear II) or a fourth the gearwheel 7 (fourth gear IV, left in FIG. 1) on a further gear shaft 8. The transmission is purely exemplary and correspondingly schematized in order to elucidate an embodiment of the present disclosure.

In the right region of FIG. 1, three (cross) sections, which are spaced apart from one another in the axial or longitudinal direction of a contour arrangement, are drawn or illustrated horizontally adjacent to one another. An actuator in the form of a selector shaft is illustrated in solid black is in a neutral position in a first gate selection position.

In FIG. 2, which is arranged directly thereunder, these sections are horizontally illustrated in the some position for a first gear selection position in the first gate selection position in order to elucidate an engaging adjustment of a first actuating member.

In FIG. 3, which is arranged directly above FIG. 1, these sections are once again horizontally illustrated in the same position for an additional gear selection position in the first gate selection position in order to elucidate an engaging adjustment of an additional actuating member.

In FIG. 4, which is arranged on the bottom, these sections are once again illustrated horizontally in the same position for another gate selection position, wherein the actuator or the selector shaft is once again in a neutral position in order to elucidate a motion of the actuator or the selector shaft in a gate selecting direction.

FIG. 5 shows the motor vehicle transmission arrangement according to FIG. 4, wherein another section through a further additional contour is illustrated in the other gate selection position in the right region of FIG. 5.

According to a comparison, in particular, of FIGS. 1 and 4, the actuator or the selector shaft can be adjusted into a first gate selection position illustrated in FIGS. 1-3 in a gate selecting direction extending perpendicular to the plane of projection of FIGS. 1-4. The first actuating member, which features an engagement finger 9, can in this first gate selection position be adjusted into a first gear selection position illustrated in FIG. 2 in a gear selecting direction in the form of a mathematically positive rotation.

The contour arrangement, of which three sections in the same axial positions are respectively illustrated in FIGS. 1-4, features a first contour 10 with an engagement section 11 that is functionally connected to the first shifter 1, particularly by a first selector shaft and selector fork as indicated with dot-dash lines in FIG. 1, in order to engage the first gear I of the motor vehicle transmission. The first contour 10 is adjusted into the first gear selection position as indicated with a motion arrow in FIG. 2 due to an engaging adjustment of the engagement finger 9 of the first actuating member cooperating with the engagement section 11 of the first contour 10, which can be gathered from a synopsis of FIGS. 1, 2, wherein the first contour causes the first gear I to be engaged by the first synchronizer 1 functionally connected thereto.

The actuator in the form of the selector shaft features an additional actuating member with an engagement finger 12 that in the first gate selection position can be adjusted into an additional gear selection position illustrated in FIG. 3 opposite to the gear selecting direction or in the clockwise direction, respectively.

The contour arrangement features an additional contour 13 with an engagement section 14 that is functionally connected to the additional shifter 5, particularly by an additional selector shaft and selector fork as indicated with double dot-dash lines in FIG. 1, in order to engage the second gear II of the motor vehicle transmission. The additional contour 13 is adjusted into the additional gear selection position as indicated with a motion arrow in FIG. 3 due to an engaging adjustment of the engagement finger 12 of the additional actuating member cooperating with the engagement section 14 of the additional contour 13, which can be gathered from a synopsis of FIGS. 1, 3, wherein the additional contour causes the second gear II to be engaged by the additional synchronizer 5 functionally connected thereto.

The actuator in the form of the selector shaft features a further actuating member with an engagement finger 15 that in the other gate selection position illustrated in FIG. 4 can be adjusted into a further gear selection position, which corresponds to the additional gear selection position of the additional actuating member or engagement finger 12, opposite to the gear selecting direction or in the clockwise direction, respectively.

The contour arrangement features a further contour 16 with an engagement section 17 that is functionally connected to the first shifter 1, particularly by a further selector shaft and selector fork as indicated with dot-double dash lines in FIG. 1, in order to engage the third gear III of the motor vehicle transmission. The further contour 16 is adjusted into the further gear selection position analogous to the engaging adjustment of the additional contour 13 illustrated in FIG. 3, namely due to an engaging adjustment of the engagement finger 15 of the further actuating member cooperating with the engagement section 17 of the further contour 16, wherein the further contour causes the third gear III to be engaged by the first synchronizer 1 functionally connected thereto.

The fourth gear IV also can be analogously engaged by a further additional actuating member and a further additional contour as only partially indicated with broken lines in FIG. 1 in order to provide a better overview. Likewise, other (not-shown) gears can be analogously engaged.

As explained above, FIGS. 2-4, as well as the right region of FIG. 1, show three sections through the contour arrangement that are spaced apart from one another in the gate selecting direction, namely a section through the first contour 10 (left in FIGS. 2-4) that is functionally connected to the first synchronizer 1, a section through the additional contour 13 (center in FIGS. 2-4) that is functionally connected to the additional synchronizer 5, and a section through the further contour 16 (right in FIGS. 2-4) that is also functionally connected to the first synchronizer 1.

The first, the additional and the further contour 10, 13, 16 respectively feature a disengagement section 18 and are adjustable due to a disengaging adjustment of the actuating member cooperating with the contour 10, 13 or 16, which is directed opposite to the respective engaging adjustment, in order to disengage the gear engaged due to the engaging adjustment, wherein this can be gathered, in particular, from the respective figure sequence FIG. 2→FIG. 1 or FIG. 3→FIG. 2.

The first, the additional and the further contour 10, 13, 16 respectively also feature a free-running section 19 that allows an adjustment of the actuating member, which is directed opposite to an engaging adjustment of the actuating member, beyond a neutral position (see FIGS. 1, 4) without adjustment of the contour 10, 13 or 16.

The first, the additional and the further contour 10, 13, 16, as well as the actuator in the form of the selector shaft, feature locking contour sections 20 for blocking an adjustment of the contours 10, 13 and 16 in gate selection positions, in which none of these actuating members cooperates with the contour 10, 13 or 16, wherein FIGS. 1-3 show the locking contour sections 20 blocking an adjustment of the further contour 16 and FIG. 4 shows the locking contour sections 20 blocking an adjustment of the first and the additional contour 10, 13.

In addition, the actuating members respectively feature a multi-piece locking contour section 21 for blocking an adjustment of the contour 10, 13 or 16 without an engaging and disengaging adjustment of an actuating member cooperating with the contour 10, 13 or 16, particularly for blocking an adjustment of the contour 10, 13 or 16 due to an adjustment of the actuating member cooperating with the contour 10, 13 or 16, which is directed opposite to an engaging adjustment of the actuating member, beyond a neutral position (see FIGS. 1, 4).

In order to engage the first gear I, the selector shaft is adjusted into the first gate selection position illustrated in FIGS. 1-3 and rotated into the first gear selection position illustrated in FIG. 2 in this gate selection position (FIG. 1→FIG. 2). This causes the engagement finger 9 of the first actuating member to displace the first contour 10 (toward the left in FIG. 1) and this first contour engages the first gear I by the first synchronizer 1 functionally connected thereto in that it rotationally fixes the first gearwheel 2 on the gear shaft 4. In this case, the engagement finger 12 of the additional actuating member also freely rotates relative to the free-running section 19 while the locking contour section 21 of the additional actuating member blocks a displacement of the additional contour 13 and the locking contour section 20 blocks a displacement of the further contour 16.

When the selector shaft is rotated back into the neutral position (FIG. 2→FIG. 1), this disengaging adjustment of the first actuating member adjusts the synchronizer 1 back (toward the right in FIG. 1) by the disengagement section 18 of the first contour 10 and thereby once again disengages the first gear I. In this case, the locking contour section 21 of the additional actuating member also blocks an adjustment of the contour 13 due to an adjustment of the additional actuating member cooperating with the contour 13, which is directed opposite to an engaging adjustment of the additional actuating member, beyond a neutral position(see FIGS. 1, 4) and the locking contour section 20 blocks a displacement of the further contour 16 without an engaging or disengaging adjustment of the additional actuating member cooperating with the contour 13.

In order to engage the second gear the selector shaft is rotated into the additional gear selection position illustrated in FIG. 3 in the opposite direction in this first gate selection position (FIG. 1→FIG. 3). This causes the engagement finger 12 of the additional actuating member to displace the additional contour 13 (toward the right in FIG. 1) and this additional contour engages the second gear II by the additional synchronizer 5 functionally connected thereto in that it rotationally fixes the third gearwheel 6 on the gear shaft 8. In this case, the engagement finger 9 of the first actuating member also freely rotates relative to the free-running section 19 while the locking contour section 21 of the first actuating member blocks a displacement of the first contour 10 and the locking contour section 20 blocks a displacement of the further contour 16.

When the selector shaft is rotated back into the neutral position (FIG. 3→FIG. 1), this disengaging adjustment of the additional actuating member adjusts the synchronizer 5 back (toward the left in FIG. 1) by the disengagement section 18 of the additional contour 13 and thereby once again disengages the second gear II. In this case, the locking contour section 21 of the first actuating member also blocks an adjustment of the contour 10 due to an adjustment of the first actuating member cooperating with the contour 10, which is directed opposite to an engaging adjustment of the first actuating member, beyond a neutral position (see FIGS. 1, 4) and without an engaging or disengaging adjustment of the first actuating member cooperating with the contour 10.

In order to engage the third gear III, the selector shaft is adjusted into the other gate selection position illustrated in FIG. 4 and rotated into the further gear selection position in this other gate selection position analogous to the figure sequence FIG. 1→FIG. 3. This causes the engagement finger 15 of the further actuating member to displace the further contour 16 (toward the right in FIG. 1) and this further contour engages the third gear III by the first synchronizer 1 functionally connected thereto in that it rotationally fixes the second gearwheel 3 on the gear shaft 4. In this case, an engagement finger 22 of a further additional actuating member also freely rotates relative to a free-running section 19 of a further additional contour 23 as explained above with reference to the pairing of the first and the additional actuating member and the first and the additional contour 10, 13 (see FIG. 5). This contour is functionally connected, for example, to the additional synchronizer 5, but may in a not-shown modification also be functionally connected to a further additional synchronizer engaged with a fifth, sixth or seventh gear. This (further) additional synchronizer 5 is adjusted by the engagement section 24 of the further additional contour 23 due to an oppositely directed engaging adjustment of the engagement finger 22 as explained above with reference to the pairing of the first and the additional actuating member and the first and the additional contour 10, 13. In this case, the locking contour sections 20 blocks a displacement of the first and the additional contour 10, 13.

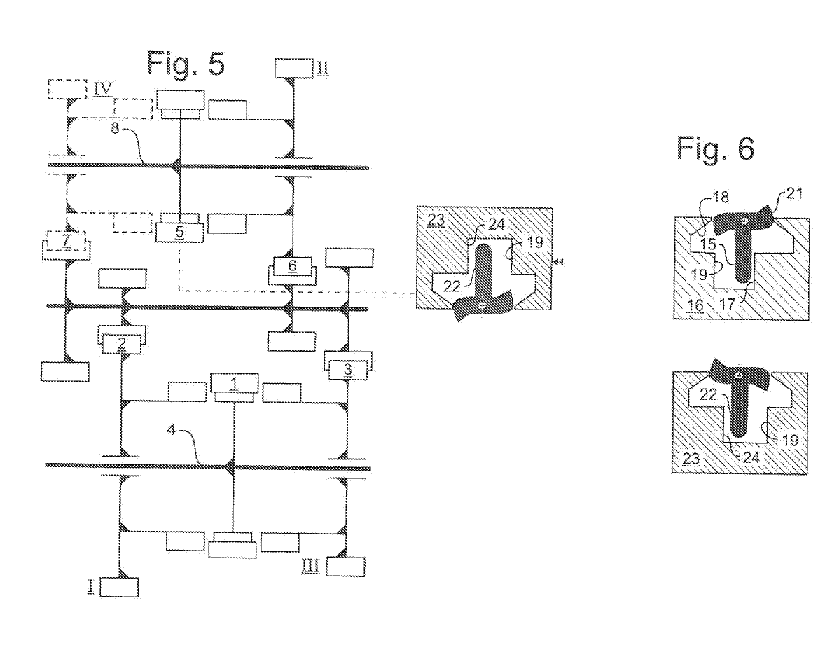

FIG. 6 shows on the top a section corresponding to the right section of FIG. 4 through a motor vehicle transmission arrangement of a motor vehicle according to another embodiment of the present disclosure for the other gate selection position, and on the bottom another section corresponding to the additional section of FIG. 5 through this motor vehicle transmission arrangement according to another embodiment of the present disclosure.

Corresponding characteristics are identified by identical reference symbols such that we refer to the preceding description of the embodiments according to FIGS. 1-5 and only the differences are discussed below.

It can be gathered that the first or fourth gear is in the embodiment according to FIGS. 1-5 engaged depending on the gate selection position due to a mathematically positive rotation of the selector shaft in the gear selecting direction whereas the second or third gear is accordingly engaged depending on the gate selection position due to an oppositely directed, mathematically negative rotation of the selector shaft opposite to the gear selecting direction.

In order to shift even-numbered gears II, IV in the same moving direction of the selector shaft and to shift odd-numbered gears I, III in the opposite moving direction of the selector shaft, particularly in conventional fashion in accordance with an H-gearshift pattern, the further actuating member with the engagement finger 15 is in the additional embodiment according to FIG. 6 arranged on the selector shaft such that it is respectively offset or turned by 180° relative to the first actuating member with the engagement finger 9 and the further additional actuating member with the engagement finger 22 is arranged on the selector shaft such that it is respectively offset or turned by 180° relative to the additional actuating member with the engagement finger 12 as elucidated by the synopsis of FIG. 6 and FIGS. 4 and 5. The further contour 16 and the further additional contour 23 are accordingly realized in the form of mirror images of the embodiment according to FIGS. 1 to 5.

In this way, the first or third gear is in the additional embodiment according to FIG. 6 engaged depending on the gate selection position due to a mathematically positive rotation of the selector shaft in the gear selecting direction whereas the second or fourth gear is accordingly engaged depending on the gate selection position due to an oppositely directed, mathematically negative rotation of the selector shaft opposite to the gear selecting direction as it is known from the familiar H-gearshift pattern.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-13. (canceled)

14. A shifting device for a motor vehicle transmission comprising:
an actuator movable in a gate selecting direction into a first gate selection position, the actuator including a first actuating member positionable into a first gear selection position in a gear selecting direction, and a second actuating member positionable into a second gear selection position opposite to the gear selecting direction; and
a contour arrangement including a first contour having a first engagement section operably connected to a first shifter adjustable into the first gear selection position and configured to engage a first gear due to an engaging adjustment of the first actuating member cooperating with the first engagement section, and a second contour having an second engagement section operably connected to a second shifter, which differs from the first shifter, adjustable into a second gear selection position and configured to engage a second gear due to an engaging adjustment of the second actuating member with the second engagement section.

15. The shifting device of claim 14 wherein the actuator is adjustable into a second gate selection position, which differs from the first gate selection position, and further comprising:
a third actuating member of the actuator adjustable into a third gear selection position; and
a third contour of the contour arrangement having a third engagement section operably coupled to the first shifter adjustable into the third gear selection position and configured to engage a third gear due to an engaging adjustment of the third actuating member cooperating with the third engagement section.

16. The shifting device according to claim 15, further comprising a fourth actuating member of the actuator adjustable into a fourth gear selection position in the second gate selection position, and a fourth contour of the contour arrangement having a fourth engagement section operably coupled to the second shifter adjustable into the fourth gear selection position and configured to engage a fourth gear due to an engaging adjustment of the fourth actuating member cooperating with the fourth engagement section.

17. The shifting device according to claim 14, wherein the first and second actuating members and the first and second contours are spaced apart from one another in the gate selecting direction.

18. The shifting device according to claim 14, wherein at least one of the contours comprises a disengagement section adjustable due to a disengaging adjustment of the actuating member cooperating with the contour, which is directed opposite to the engaging adjustment, in order to disengage the gear engaged due to the engaging adjustment.

19. The shifting device according to claim 18, wherein at least one of the contours comprises a free-running section that allows an adjustment of the actuating member, which is directed opposite to an engaging adjustment of the actuating member, beyond a neutral position without adjustment of the contour.

20. The shifting device according to claim 14, wherein at least one of the contours comprises a free-running section that allows an adjustment of the actuating member, which is directed opposite to an engaging adjustment of the actuating member, beyond a neutral position without adjustment of the contour.

21. The shifting device according to claim 14, wherein at least one of the contours and the actuator comprise a locking contour section for blocking an adjustment of the contour in at least one of the gate selection positions.

22. The shifting device according to claim 14, wherein the first gear and the second comprise numerically successive gear assemblies, which are axially separated by one or more gearwheels.

23. The shifting device according to 14, wherein the actuator is axially adjustable in the gate selecting direction and rotationally adjustable in and opposite to the gear selecting direction.

24. The shifting device according to claim 14, wherein at least one of the shifters comprises a synchronizer for rotationally fixing a gearwheel on a gear shaft.

25. The shifting device according to claim 14, wherein the actuator is manually adjusted between the first and second gear selection positions.

26. A motor vehicle transmission comprising a plurality of gears a shifting device according to claim 14 selectively engaging and disengaging the gears.

27. The motor vehicle transmission arrangement according to claim 26, wherein the motor vehicle transmission comprises a dual clutch transmission.

28. The motor vehicle transmission arrangement according to claim 27, wherein the motor vehicle transmission comprises a high-torque starting gear for heavy loads.

29. The motor vehicle transmission arrangement according to claim 28, wherein the motor vehicle transmission comprises at least seven forward gears.

30. A motor vehicle comprising a powertrain assembly including an internal combustion engine and motor vehicle transmission arrangement according to claim 26.
